(19) United States
(12) Patent Application Publication
(10) Pub. No.: US 2025/0061818 A1
(43) Pub. Date: Feb. 20, 2025

(54) HYPOTHESIS TESTING AND NORMAL DISTRIBUTION EDUCATIONAL DEVICE

(71) Applicant: Leslie Elizabeth Buddington, New Ipswich, NH (US)

(72) Inventor: Leslie Elizabeth Buddington, New Ipswich, NH (US)

(21) Appl. No.: 18/451,365

(22) Filed: Aug. 17, 2023

(51) Int. Cl. G09B 23/02

(52) U.S. Cl. CPC G09B 23/02

(57) ABSTRACT

An educational device and method for teaching statistical concepts such as the normal curve, hypothesis testing for multiple groups and a single sample that includes a box with pegs forming a grid, an entrance zone through which balls can be placed by users through various holes, and a finishing zone through which balls sit in separated chambers on top of a removable stopper track before dropping into a collection bin. Pegs in the grid are offset relative to adjacent rows. The front is transparent. Dropping multiple balls through the center top hole illustrates a normal curve. Dropping multiple balls through different top holes results in multiple approximate normal curves, which illustrates basic principles of hypothesis testing. The use of different colored balls in different top holes further elucidates this concept. The device and educational method by which it is used can be modified to accommodate for different ages and purposes.

### BACKGROUND OF THE INVENTION

Publication Classification:

U.S. Cl. A63F 3/0415 Mathematical Educational toy

U.S. Cl. A63F 3/0457 Mathematical models or topics

U.S. Cl. A63F 7/022 Pachinko

An educational device and method for teaching the normal curve and hypothesis testing that includes an upright box with pegs forming a grid, the grid including an entrance zone through which rounded tokens or balls can be placed through various holes in order to enter the grid and a finishing zone through which rounded tokens or balls sit in separated chambers on top of a removable stopper track before being dropped into a collection bin that can be accessed. The rows of pegs in the grid are offset relative to adjacent rows. The front is plexiglass or other transparent material. The back is wood or could be plastic or plexiglass. The finishing zone includes multiple finishing chambers, each configured to receive rounded tokens or balls. There is a removeable stopper track at the bottom of the finishing zone, through which rounded tokens or balls can pass into an accessible collecting bin.

Students in the United States score lower on reading in the international PISA (Programme for International Student Assessment) test, a test that assesses student understanding of concepts using real world tasks. In 2018, students in the US scored below the average in mathematics (OECD, 2019). Their mathematics scores have remained stable and below international average for over two decades (OECD, 2019). Famous cognitive developmental psychologist Jean Piaget is known for his theory that children learn through hands-on learning with physical materials (see Berk, 2021). Hands-on learning opportunities improve students' understanding even in college age (Fischer, 2022). Hands-on learning can be particularly impactful for mathematical understanding (Mix, 2009).

The principle aim is to give an object that can be manipulated by learners as well as to provide an aid for teaching mathematical concepts, specifically statistical concepts, i.e. the normal curve, samples, comparing two groups, and hypothesis testing. The purpose or essential function of the invention is to teach statistical concepts to learners who may be children through college age.

Sir Francis Galton described what is now called a Galton board in 1889. In its usual configuration, balls or beads enter via one central hole at the top of the grid of pegs before falling through to the finishing slots. The current invention has multiple holes through which balls or rounded tokens can enter at the top of the grid in order to illustrate multiple normal distributions. In past iterations, Galton boards are self-contained with the balls or beads not accessible to the user. The current invention has balls or rounded tokens that are purposely accessible to the user.

Pachinko-style boards have been used for means other than educational ones for over a century, as witnessed by U.S. Pat. Nos. 492,178 and 513,224 to Young for gambling apparatuses, U.S. Pat. No. 4,015,847 to Myers for entertainment and gambling purposes, U.S. Pat. No. 20050269785 A1 to Shiu and Roth for the entertainment of customers and as a money-making device, to U.S. Pat. Nos. 10,235,842 and 20170333781 to Glassman for entertainment by use of a pachinko-style board that has bumpers that alter the degree of chance of objects falling into any of the slots on the bottom as opposed to a normal distribution, and U.S. Pat. No. 20210241584 to Blinov and Mescerjakovs for entertainment by use of a pachinko-style board with electronic components that create random outputs instead of a normal distribution.

While these patents use a pachinko-style board, their object is for gambling or entertainment purposes, whereas the utilization of an accessible Galton board for educational purposes has not been addressed. The U.S. Pat. Nos. 492,178, 513,224 and U.S. Pat. No. 4,015,847 were for geared towards adults and for gambling purposes. U.S. Pat. No. 20050269785 A1 is primarily for the entertainment of customers in a restaurant and as a money-making device. U.S. Pat. Nos. 10,235,842, 20170333781 and U.S. Pat. No. 20210241584 are specifically designed to create random outputs and purposefully designed not to create the normal distribution outcome.

### OTHER PUBLICATIONS

“Galton board,” https://en.wikipedia.org/wiki/Galton_board, last edited Jun. 5, 2023. “Pachinko,” https://en.wikipedia.org/wiki/Pachinko, last edited Jul. 18, 2023.

### References

Berk, L. E. (2021). Infants, children, and adolescents (9th ed.). Sage Publications.

Fischer, K. (2022). The power of “high impact” learning. Reimagining the student experiences: How colleges can help students connect, belong and engage. Chronicle of Higher Education. Galton, F. (1894). Natural Inheritance. Macmillan.

Mix, K. S. (2009). Spatial tools for mathematical thought. In Kelly S. Mix, Linda B. Smith, and Michael Gasser (eds), The Spatial Foundations of Language and Cognition, Explorations in Language and Space. Oxford Academic.

OECD (2019). Programme for international student assessment (PISA) results from PISA 2018. https://www.oecd.org/pisa/publications/PISA2018_CN_USA.pdf#:˜:text=Students%20in%20the%20United%20States%20performed%20above%20the,in%20at%20least%20two%20of%20these%20three%20subjects

### BRIEF SUMMARY OF THE INVENTION

The present invention relates to a wooden or plastic box-shaped device to be used for educational purposes. There are several options for entry at the top of the device, which can used to elucidate hypothesis testing by creating multiple normal curves. The use of different colored balls or rounded tokens being dropped into different holes at the top further illustrates the concept of multiple normal distributions that overlap. The disadvantages of the prior art may be overcome by allowing users to manipulate the balls or rounded tokens in a manner that is easy to operate. The disadvantages of the prior art may be overcome by having multiple holes through which balls or rounded tokens can enter the grid. The disadvantages of the prior art may be overcome by increasing the width of the device, such that more than one normal curve can be approximated. The device includes multiple holes at the top, a grid with pegs in alternate rows in the body cavity, slots for collecting balls or rounded tokens at the bottom of the grid, a removable stopper track for keeping balls or tokens secure in the slots, and a collection bin at the bottom that is able to be opened.

Within the body cavity section are rows of pegs forming a grid through which balls or rounded tokens can travel, as well as predetermined slots in the finishing zone where the balls or rounded tokens finish. The pegs are permanently fixed within the body cavity section, with each row of pegs offset from the rows adjacent. In operation, balls or rounded tokens are dropped in the top through one or more holes. Gravity guides the balls or rounded tokens into one of the slots at the bottom of the grid. The slot separator walls are spaced so that each is directly below a dowel in the last row. The balls or rounded tokens sit on a removable stopper track, upon removal of which the balls or rounded tokens drop into the collection bin. The collection bin includes a knob to facilitate opening the collection bin. By using different colored balls or rounded tokens placed into different holes at the top, gravity will approximate multiple normal distributions.

It is an object of the present invention to provide a device to educate users regarding probability, the normal distribution, hypothesis testing for multiple groups, and single score hypothesis testing.

Another object of the invention is to provide an interactive learner experience, thus facilitating understanding of probability, the normal distribution, hypothesis testing for multiple groups, and single score hypothesis testing through hands-on interaction by users.

Another object of the invention is to have a width that is wide enough to approximate two normal distributions at once, such that hypothesis testing for two or more groups might be illustrated visually.

Still another object of the invention is to have the use of multiple locations to start multiple-colored balls or rounded tokens at the top of the device, such that hypothesis testing of a single score might be illustrated visually.

A further object of the invention is to provide entertainment to users while still having them learn important mathematical concepts.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTIONS OF SEVERAL VIEWS Of THE DRAWINGS

FIG. 1A is a front perspective view of the preferred embodiment.

FIG. 1B is a side perspective view of the preferred embodiment.

FIG. 1C is a view of the top of the preferred embodiment.

### DETAILED DESCRIPTION OF THE INVENTION

In the following detailed description of the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting.

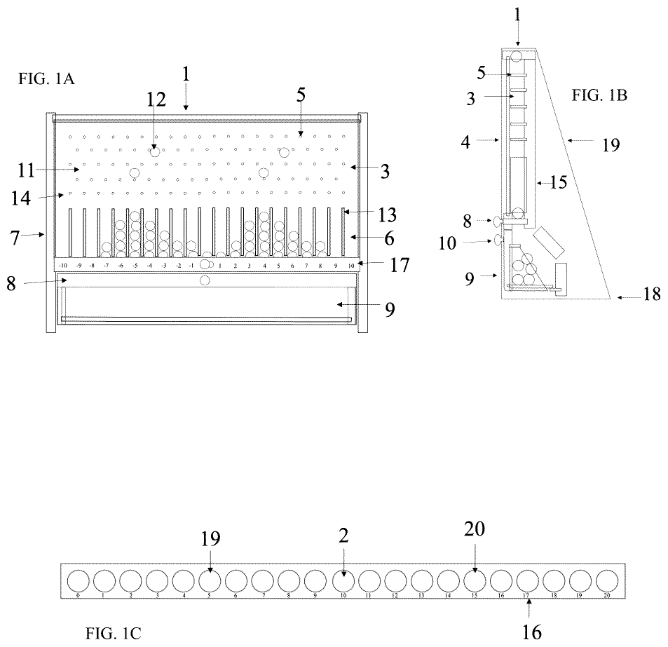

Referring to FIG. 1A, 1B and 1C, the present invention comprises an entrance zone 1 with multiple holes 2 at the top of a body cavity 3, with at least the front side 4 of the body cavity transparent and the back side of the body cavity consisting of a grid of pegs 5 in rows offset to adjacent rows, slots 6 in a finishing zone 7, and a removable stopper track 8 separating finishing zone 7 from the collection bin 9 at the bottom of the device which can be opened 10.

FIG. 1A depicts the front view of a simplified version of the device according to some embodiments. The device has an entrance zone 1 at the top of the device with multiple holes laterally across the top through which rounded tokens or balls transit through the body cavity 3 towards the slots 6 in the finishing zone 7.

The entrance zone 1 has a variety of holes 2 for inserting balls or rounded tokens.

The back side of the body cavity 3 has a wall with a series of pegs 5 evenly spaced. The rows of pegs 5 in the grid 3 are offset relative to an adjacent one of the rows of the pegs, such that the pegs in any row are located in-between the pegs in adjacent rows. Spaces between pegs 11 are sized relative to the rounded tokens or balls being used 12 such that rounded tokens or balls can fit through spaces between pegs with minimal additional clearance.

At least the front side 4 of the body cavity 3 is transparent, preferably made of plexiglass. The back wall 15 is preferably wood, but could also be plastic or plexiglass.

Finishing zone 7 with vertical separator walls 13 segregate one slot 6 from the next. At least the front side of finishing zone 7 is transparent, preferably made of plexiglass.

Separator slots 6 are sized relative to the size of the rounded tokens or balls being used 12 such that there is minimal additional clearance. Separator slots 6 are located directly beneath the pegs in the adjacent row 14.

Below finishing zone 7 is a removable stopper track 8 that slides out to allow rounded tokens or balls 12 to fall into collection bin 9.

FIG. 1B depicts a simplified version of the device from the side view and helps to illustrate the opening of the collection bin 9 and the opening of the removable stopper track 8 on which the balls or tokens 12 sit until they are released into the collection bin 9.

FIG. 1B also helps illustrate that the width from front to back of the body cavity 3 is only just greater than the width of the balls or rounded tokens being used 12. The front wall 4 is transparent so that the trajectory of the balls or rounded tokens may be viewed. The back wall 15 may also be transparent but may be made of wood or plastic some configurations. The width of the front wall 4 and back 15 walls are minimally larger than the balls or rounded tokens being used with the device in order to ensure that the balls or rounded tokens will be directed through the pegs 5.

FIG. 1C depicts a simplified version of the top of the device and helps to illustrate the multiple openings 2 through which balls or tokens 12 enter the body cavity 3. The number of holes depicted is for illustrative purposes and may differ in actual device. Numbers 16 labeling the holes 2 will help with differentiating among the holes when the device is being used for illustrating hypothesis testing with multiple groups. There may be numbers 17 on the front of the finishing zone 7 labeling the slots 6 to aid in averaging each sample. Numbers 17 depicted here are one proposed configuration. The actual number labels could vary based on age of users and purpose of the instruction, such as numbers from 0-20 or effect sizes.

In addition to the wooden or plastic base 18 for stabilizing the device, is a brace 19 located at the rear of the device.

In operation of the preferred embodiment, users use the top center hole 2 to drop 30-50 balls or rounded tokens 12, one at a time. Balls or rounded tokens 12 will form a normal distribution in the finishing zone 7. If multiple devices are used at once, users can compare each sample distribution and see that all samples approximate the normal distribution. If only one device is in use, the device can be emptied and each new round of dropping balls through the center hole would illustrate a slightly different approximation of a normal distribution.

Depending on users' ages and purpose of instruction, the average of each distribution could be computed (with number of balls in each slot multiplied by the slot numbers 17). The average from each device or round would illustrate different sample means.

Depending on users' ages and purpose of instruction, the device could be used by dropping 30 or so of a single-color ball or token in one of the top holes (i.e. 19) and the same number of balls or tokens of a different color in a hole on the opposite side (i.e. 20). When the balls or tokens of different colors drop through the grid of pegs 3 to the finishing zone 7, they will each form an approximate normal distribution which overlaps the other. This would illustrate approximate normal distributions of different groups visually, thus aiding users' comprehension of what is happening during hypothesis testing for multiple groups.

Depending on users' ages and purpose of instruction, a normal distribution could be created by dropping 30-50 balls or colored tokens in one of the top openings 2. One ball or token of a different color could then be dropped into any of the other top openings to see where in the distribution it fell. Using a ball of a third color and dropping it into a third hole would further illuminate this concept. This practice would help users to visualize what happens in hypothesis testing with a single score.

1. A product of a Galton board-type device with no bumpers on the sides and with multiple holes at the top that are accessible to the user and a collection bin which is accessible to the user on the bottom, such that balls or rounded tokens can be dropped in various holes on the top and taken out from the bottom collection bin.

2. An educational method for using the product in claim 1 that allows for interaction with balls or rounded tokens while using the board.

3. An educational method for using the product in claim 1 by using the holes at the top of the board and numbers on the board to illustrate statistical principles pertaining to a normal distribution.

4. An educational and interactive method for using the product in claim 1 by varying the holes used at the top of the board and numbers on the board to illustrate statistical principles pertaining to more than one normal distribution.

5. An educational and interactive method for using the product in claim 1 by varying the holes used at the top of the board, numbers on the board, and the use of different color balls or rounded tokens to illustrate statistical principles pertaining to sample sizes and hypothesis testing for multiple groups.

6. An educational and interactive method for using the product in claim 1 by varying the holes used at the top of the board and different color balls or rounded tokens to illustrate statistical principles pertaining to hypothesis testing for a single score.
